(19) United States
(12) Patent Application Publication
(10) Pub. No.: US 2013/0212193 A1
(43) Pub. Date: Aug. 15, 2013

(54) SYSTEM FOR SHARING IMAGES

(71) Applicant: Mohamed Ahmed, Athens, GA (US)

(72) Inventor: Mohamed Ahmed, Athens, GA (US)

(21) Appl. No.: 13/672,112

(22) Filed: Nov. 8, 2012

Related U.S. Application Data
(60) Provisional application No. 61/598,190, filed on Feb. 13, 2012.

(51) Int. Cl. G06F 15/16

(52) U.S. Cl. 709/206

(57) ABSTRACT

An embodiment of the present invention provides a method for sharing studies and medical images via a one click mechanism whereby only an email address is required to share a medical image or a study with a third party without assistance from information technology administrators or copying patient image and information somewhere else.

### CROSS-REFERENCE TO RELATED APPLICATION

The present application claims priority to U.S. Provisional Application No. 61/598,190, filed Feb. 13, 2012, entitled “System that allows automatic access to anyone to view a specific study or studies online, just by entering the email address of the person we are sharing the studies with on a web-based PACS viewer.”

### BACKGROUND OF THE INVENTION

The present invention relates to medical images and, more particularly, to securely and quickly sharing medical images and its information without the need of re-sending, copying or manually assigning user rights

The practice of sharing medical images and studies between physicians can be time consuming. There are multiple steps to set up an account for sharing a study online.

Other systems have time consuming processes for setting up accounts & security settings for sharing studies. In the existing systems, one will have to log-in to his/her PACS system with his/her account, search and the share to account. If the share to account exists, he/she will share patient with this account. If the share to account does not exist, he/she will have to ask for PACS admin help to create account and assign him security privileges to see only this patient studies.

End-users in the medical industry are extremely busy. These users do not have enough time to do all the extra steps required by other systems, and they will normally ask for help from facility IT administrators. However, in emergency situations, they need a quick and easy way to share a study. Existing systems require users to do multiple steps for sharing a study with others.

Therefore, there is a need for a system that eliminates multiple steps for sharing studies securely.

### SUMMARY OF THE INVENTION

In one aspect of the present invention, an image sharing system comprises a server which hosts studies securely; a user; and a recipient; wherein the user may utilize the server to share studies with the recipient by selecting said studies and entering the recipient's email address; and the recipient receives an email with instructions for accessing the shared study securely from the same server and without exposure of confidential patient information.

These and other features, aspects and advantages of the present invention will become better understood with reference to the following drawings, description and claims.

### BRIEF DESCRIPTION OF THE DRAWINGS

FIG. 1 is a flowchart illustrating an exemplary embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an embodiment of the present invention provides a method for sharing studies and medical images via a one click mechanism whereby only an email address is required to share an image or study with a third party.

The system of an exemplary embodiment of the current invention enables the sharing of medical images, studies and other sensitive data based on email addresses without exposing confidential patient information.

In an exemplary embodiment of the invention, the user is able to create a sharing session each time a user shares a study or multiple studies with another user. The sharing session is independent of other user privileges defined in the system. When a user logs-in to his account, he will see all the studies assigned to them or shared with them through a OneClick Share® mechanism. If they don't have any studies assigned to them, the user will only view the shared studies.

Once a user is logged in and selects a study for sharing, they have to enter the email address of a physician. The system will check if that email address is already associated with an account. If it is associated with another account, the system will alert the user that the email entered is associated with said account and ask the user if they would you like to proceed. If the user decides to proceed, the system will share that study to this account by creating a sharing session. If there is no existing account for the email entered by the user, the system will generate a new account based on the email entered. The system will also assign medical image viewing default settings to this account. Furthermore, the system will also assign the study to this newly created account (by creating a share session) and generate an email containing the link and credentials, such as username & a temporary password. There is no limitation on image sharing. Physicians can share with physicians or patients. Patient can share with family member of other physicians. Information shared to physician can be shared with other physicians.

In another embodiment of the invention, after uploading the study to a server such as the PaxBox® server, the user can share the study using One Click Share®. The user may select the study they want to share, right click and select One Click Share® from the menu. The menu option prompts the user to enter the email of a physician in the box provided, and also add a custom message for the recipient. Once the email address and optional message is entered, the system transmits the message to the physician with all the required information, such as username and temporary password, for accessing the shared study.

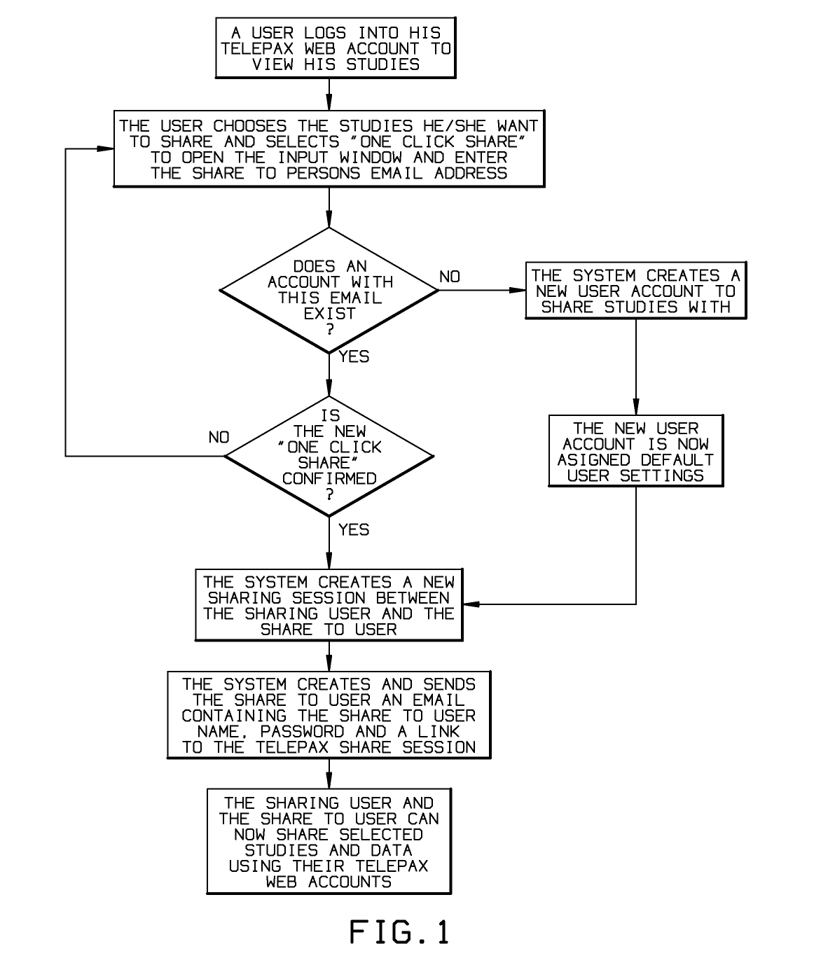

Referring to FIG. 1, a user is able to log into a web account such as a PaxBox® web account to view his studies. The term studies is used hereafter to include medical studies, images and any other sensitive data that may be shared by doctors, physicians or medical professionals.

The user may choose the studies he wants to share and selects “One Click Share®” to open the input window and enter the email address of the recipient of the shared information.

When the user enters the recipient email, the system determines if that email address is already attached to an existing account. If the email address is new, the system creates a new user account to share studies with and the new user account is assigned default user settings. For example, when a sharing session is created for a new person, a new user ID is created. This user ID belongs to the provider that created this sharing session. The default settings of this provider will apply to this new user by default. The user can change it later. These default settings include but not limited to: zoom ratio, zooming method, on screen image ordering (panels & images), preferred window & level to view the screen, Auto cine, etc.

The system then creates a new sharing session between the sharing user and the share to user (recipient). If the email address is known to the system, the system determines if the One Click Share® is confirmed. If the One Click Share® is confirmed, the system creates a new sharing session between the sharing user and the share to user (recipient). If the One Click Share® is not confirmed, the process is terminated and the user is prompted to enter another email address to share studies with.

In an alternative embodiment, the user is able to instruct the system to send a reminder to the recipient whose email address is not confirmed, so that the recipient may confirm the One Click Share process and enable sharing between the user and the recipient. The present invention doesn't ordinarily send confirmations. But if the user exists already in the system (identified by the email address), the system may tell the user that there is a user with this name and affiliated to that provider. If the user agrees to continue, a sharing session will be created for the existing user without changing his default settings.

Once a new sharing session has been created, the system creates and sends the share to a user with an email containing the share information, the username and password to link to the share session.

The sharing user and the share to user can now share selected studies and data using their PaxBox® (or web-based medical image storage device) web accounts.

The above-discussed embodiments include software that performs certain tasks. The software discussed herein may include script, batch, or other executable files or web-based application. The software may be stored on a machine-readable or computer-readable storage medium, and is otherwise available to direct the operation of the computer system as described herein and claimed below. In one embodiment, the software uses a local or database memory to implement the data transformation and data structures. The local or database memory used for storing firmware or hardware modules in accordance with an embodiment of the invention may also include a semiconductor-based memory, which may be permanent, removable or remotely coupled to a microprocessor system.

The computer-based data processing system described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries.

It should be understood, of course, that the foregoing relates to exemplary embodiments of the invention and that modifications may be made without departing from the spirit and scope of the invention as set forth in the following claims.

What is claimed is:

1. A system for sharing images, comprising:
a server that hosts studies securely;
a machine; and
a program product comprising machine-readable program code for causing, when executed, the machine to perform the following process steps:
prompting a user to select selected studies from among the studies to share with a recipient;
prompting the user to enter an email address of the recipient;
receiving a selection of the selected studies;
receiving the email address of the recipient;
sending an email notification to the recipient based at least in part on the selection of the selected studies and the email address of the recipient,
wherein the email includes instructions for accessing a sharing of the selected studies without disclosing confidential patient information.

2. The system of claim 1, wherein the program product causes the machine to create a new account for the recipient if the email address is new.

3. The system of claim 1, wherein the program product causes the machine to create a secure sharing session between the user and the recipient after the user confirms the share.

4. The system of claim 1, wherein the server is a web-based medical image storage device.

5. The system of claim 1, wherein the program product causes the machine to send a reminder to the recipient so that the recipient may confirm the sharing.

6. The system of claim 1, wherein the program product causes the machine to assign default user settings for medical image viewing and processing after the user confirms the sharing.

7. The system of claim 1, wherein the program product causes the machine to prompt the user to select settings the recipient will receive upon confirming the sharing.

8. The system of claim 1, wherein the step of sending is performed after receiving a one-click instruction from the user.
